(19) United States
(12) Patent Application Publication
(10) Pub. No.: US 2025/0324172 A1
(43) Pub. Date: Oct. 16, 2025

(54) SOLID-STATE IMAGING DEVICE AND DRIVER CIRCUIT

(71) Applicant: SONY SEMICONDUCTOR SOLUTIONS CORPORATION, KANAGAWA (JP)

(72) Inventor: YOHEI OTA, KANAGAWA (JP)

(21) Appl. No.: 18/865,837

(22) PCT Filed: Mar. 27, 2023
(86) PCT No.: PCT/JP2023/012142

§ 371 Date: Nov. 14, 2024

(30) Foreign Application Priority Data
May 24, 2022 (JP) 2022-084200

(51) Int. Cl. H04N 25/77; H04N 25/709

(52) U.S. Cl. CPC H04N 25/77; H04N 25/709

(57) ABSTRACT

The present technology improves uniformity of driving of a driver circuit. A solid-state imaging device includes a pixel array unit, a current generation unit, and a current-driven unit. In the pixel array unit, pixels are arranged in a matrix in a row direction and a column direction. The current generation unit generates a current. The current-driven unit is driven with a divided current resulting from dividing the current generated by the current generation unit to generate a drive signal for the pixels on the basis of a control signal. A voltage-driven unit that is supplied with a second power supply voltage different from a first power supply voltage supplied to the current generation unit to generate a drive signal for the pixels on the basis of the control signal may be further provided.

### TECHNICAL FIELD

The present technology relates to a driver circuit and a solid-state imaging device. More specifically, the present technology relates to a current-driven driver circuit and a solid-state imaging device.

### BACKGROUND ART

A solid-state imaging device is provided with a driver circuit that drives pixels to perform an imaging operation. This driver circuit is provided with a plurality of drivers having the same driving force. Some of such driver circuits have a configuration where a bias voltage is distributed from a bias circuit to a plurality of local blocks via a long wiring (see, for example, Patent Document 1).

### CITATION LIST

### Patent Document

Patent Document 1: Japanese Patent Application Laid-Open No. 2021-129170

### SUMMARY OF THE INVENTION

### Problems to be Solved by the Invention

In the above-described related art, however, a transistor that generates a current causing the driver circuit to operate as a current driver is voltage-driven on the basis of a power supply voltage. Therefore, there has been a possibility that IR drop increases with an increase in the number of wirings through which the power supply voltage is supplied, the gate-to-source voltage of the transistor decreases, and the slew rate decreases accordingly.

The present technology has been made in view of such circumstances, and it is therefore an object of the present technology to improve uniformity of driver circuit driving.

### Solutions to Problems

The present technology has been made to solve the above-described problems, and a first aspect of the present technology is a solid-state imaging device including: a pixel array unit in which pixels are arranged in a matrix in a row direction and a column direction; a current generation unit that generates a current; and a current-driven unit that is driven with a divided current resulting from dividing the current generated by the current generation unit to generate a drive signal for the pixels on the basis of a control signal. This configuration produces an effect that the drive signal for the pixels is generated on the basis of the current drive.

Furthermore, in the first aspect, the current generation unit may control the current on the basis of the control signal. This configuration produces an effect that it is possible to accommodate an increase or decrease in the number of current-driven units to be simultaneously driven while maintaining the slew rate of the current-driven unit constant.

Furthermore, in the first aspect, the control signal may include designation information specifying a current-driven unit that is selected when driving the pixels. This configuration produces an effect that the current-driven unit that drives the pixels is selected.

Furthermore, in the first aspect, the designation information may include an address assigned to each of the current-driven units. This configuration produces an effect that the current-driven unit that generates the drive signal when driving the pixels is designated.

Furthermore, in the first aspect, the control signal may include the addresses for the number of the current-driven units to be simultaneously driven, and a signal that is toggled according to the number of the current-driven units to be simultaneously driven. This configuration produces an effect that the current-driven units to be simultaneously driven are identified.

Furthermore, in the first aspect, the current generation unit may control the current on the basis of the number of the current-driven units to be simultaneously driven extracted from the control signal. This configuration produces an effect that the current used to drive the current-driven units is controlled on the basis of internal information generated in the solid-state imaging device.

Furthermore, in the first aspect, the current generation unit may control the current on the basis of a counter output of the signal toggled according to the number of the current-driven units to be simultaneously driven. This configuration produces an effect that the current is controlled according to the number of current-driven units to be simultaneously driven.

Furthermore, in the first aspect, the current-driven units identified by the addresses corresponding to the counter output may be current-driven simultaneously on the basis of the current controlled on the basis of the counter output. This configuration produces an effect that the plurality of current-driven units designated by the control signal are current-driven simultaneously.

Furthermore, in the first aspect, a voltage-driven unit that is supplied with a second power supply voltage different from a first power supply voltage supplied to the current generation unit to generate a drive signal for the pixels on the basis of the control signal and an output terminal provided in common between the current-driven unit and the voltage-driven unit may be further included. This configuration produces an effect that the drive signal is generated by switching from a low-voltage power supply to a high-voltage power supply when driving a transistor.

Furthermore, in the first aspect, the current-driven unit may include a first switching element having one end connected to the output terminal, the voltage-driven unit may include a second switching element having one end connected to the output terminal, the first switching element may have the other end connected to a current terminal of the current generation unit, and the second power supply voltage may be supplied to the other end of the second switching element. This configuration produces an effect that switching to settling based on the voltage drive using the high-voltage power supply can be made after precharging based on the current drive using the low-voltage power supply.

Furthermore, in the first aspect, a plurality of the current-driven units may be provided, and the current generation unit may be shared by the plurality of current-driven units. This configuration produces an effect that the plurality of current-driven units is current-driven on the basis of the current generated by one current generation unit.

Furthermore, in the first aspect, the current-driven units may be connected in parallel to the current generation unit. This configuration produces an effect that the current generated by one current generation unit is divided into currents for the plurality of current-driven units.

Furthermore, in the first aspect, the voltage-driven units may be provided on a one-to-one basis for the current-driven units, and the second power supply voltage may be supplied in parallel to the voltage-driven units. This configuration produces an effect that the second power supply voltage is supplied to the plurality of voltage-driven units.

Furthermore, in the first aspect, the current-driven unit may include a transistor, a mirror current generated on the basis of a current mirror operation of the current generation unit may be input to a source of the transistor, and the control signal may be input to a gate of the transistor. This configuration produces an effect that the transistor is current-driven on the basis of the mirror current generated by the current generation unit.

Furthermore, in the first aspect, a slew rate control unit that controls a slew rate of the current-driven unit on the basis of control of the mirror current generated on the basis of the current mirror operation of the current generation unit may be further included. This configuration produces an effect that the slew rate of the drive signal is controlled on the basis of the mirror current generated by the current generation unit.

Furthermore, a second aspect is a driver circuit including a current generation unit that generates a current; and a current-driven unit that is driven with a divided current resulting from dividing the current generated by the current generation unit to generate a drive signal for a transistor on the basis of a control signal. This configuration produces an effect that the drive signal for the transistor is generated on the basis of the current drive.

### BRIEF DESCRIPTION OF DRAWINGS

FIG. 1 is a block diagram illustrating a configuration example of a solid-state imaging device according to a first embodiment.

FIG. 2 is a circuit diagram illustrating a configuration example of a driver circuit according to the first embodiment.

FIG. 3 is a block diagram illustrating a configuration example of a switching control unit and a power supply of the driver circuit according to the first embodiment.

FIG. 4 is a circuit diagram illustrating a configuration example of the switching control unit of the driver circuit according to the first embodiment.

FIG. 5 is a circuit diagram illustrating a configuration example of a logic circuit used to generate a control signal for the driver circuit according to the first embodiment.

FIG. 6 is a timing chart illustrating how the driver circuit according to the first embodiment operates.

FIG. 7 is a diagram illustrating an example of a slew rate of the driver circuit according to the first embodiment.

FIG. 8 is a diagram illustrating an example of a layout of wirings used to current-drive the driver circuit according to the first embodiment.

FIG. 9 is a block diagram illustrating a configuration example of a driver circuit according to a second embodiment.

FIG. 10 is a circuit diagram illustrating a configuration example of the driver circuit according to the second embodiment.

FIG. 11 is a circuit diagram illustrating a first example of a driver circuit according to a third embodiment.

FIG. 12 is a circuit diagram illustrating a second example of the driver circuit according to the third embodiment.

FIG. 13 is a circuit diagram illustrating a third example of the driver circuit according to the third embodiment.

FIG. 14 is a circuit diagram illustrating a configuration example of a driver circuit according to a fourth embodiment.

FIG. 15 is a block diagram illustrating a schematic configuration example of a vehicle control system.

FIG. 16 is an explanatory diagram illustrating an example of an installation position of an imaging section.

### MODE FOR CARRYING OUT THE INVENTION

Modes for carrying out the present technology (hereinafter, referred to as embodiments) will be described below. The description will be given in the following order.
1. First embodiment (example where a plurality of drivers is driven on the basis of a current generated by a current source)
2. Second embodiment (example where a current generated by a current source is controlled according to the number of drivers to be simultaneously driven)
3. Third embodiment (example where the slew rate of a drive signal output from a driver is changed on the basis of current control of a current source)
4. Fourth embodiment (example where current sources are arranged in a distributed manner between drivers)
5. Example of application to mobile object

### 1. First Embodiment

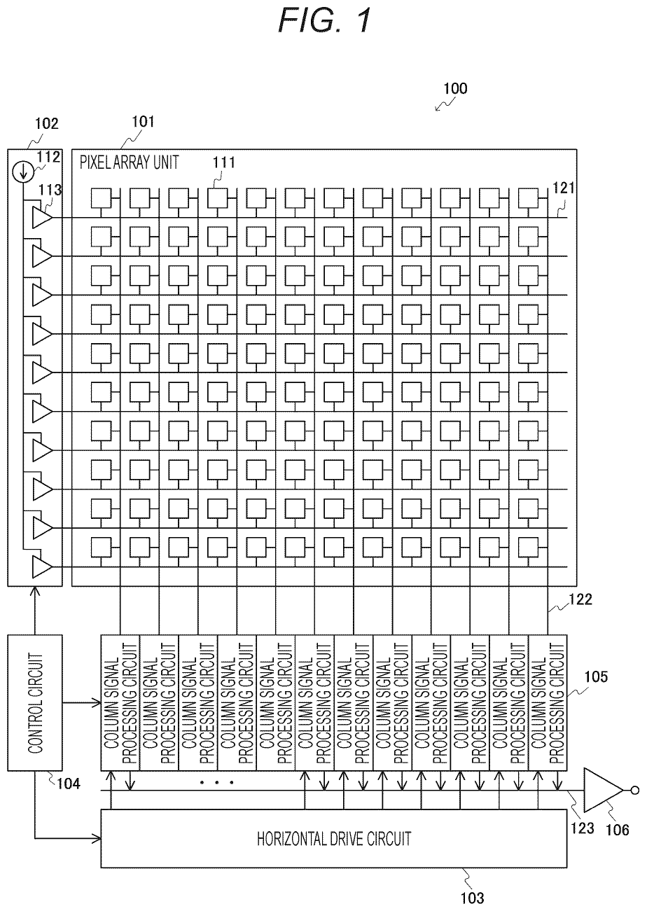

FIG. 1 is a block diagram illustrating a configuration example of a solid-state imaging device according to the first embodiment.

In the drawing, the solid-state imaging device 100 includes a pixel array unit 101, a vertical drive circuit 102, a horizontal drive circuit 103, a control circuit 104, a column signal processing circuit 105, and an output circuit 106.

The pixel array unit 101 includes a plurality of pixels 111. The pixels 111 are arranged in a matrix in a row direction and a column direction. Each pixel 111 includes a photodiode that perform photoelectric conversion and a pixel transistor. The pixel transistor may include, for example, a transfer transistor, a reset transistor, a selection transistor, and an amplification transistor.

Furthermore, the pixel array unit 101 includes a pixel drive line 121 and a vertical signal line 122. The pixel drive line 121 transmits a drive signal for driving each pixel 111 in the row direction. The vertical signal line 122 transmits a pixel signal read from each pixel 111 in the column direction. The drive signal for driving each pixel 111 may include a transfer signal for driving the transfer transistor, a reset signal for driving the reset transistor, and a row selection signal for driving the selection transistor.

The vertical drive circuit 102 drives the pixels 111 row by row via the vertical signal line 122. The vertical drive circuit 102 selectively scans, row by row, the pixels 111 of the pixel array unit 101 sequentially in the column direction. Therefore, a pixel signal based on a signal charge generated according to the amount of light received by each pixel 111 is supplied to the column signal processing circuit 105 through the vertical signal line 122.

The vertical drive circuit 102 includes a current source 112 and a driver 113. The driver 113 can be provided for each pixel drive line 121. The current source 112 can be shared by a plurality of the drivers 113. At this time, the drivers 113 can be connected in parallel to the current source 112. The driver 113 supplies the drive signal for driving the pixels 111 to the selected pixel drive line 121. The driver 113 can be driven with a divided current resulting from dividing a current generated by the current source 112 to generate the drive signal for the pixels 111 on the basis of a control signal. Note that the current source 112 is an example of a current generation unit described in the claims. The driver 113 is an example of a current-driven unit described in the claims.

The horizontal drive circuit 103 drives the column signal processing circuit 105 for each column. The horizontal drive circuit 103 may include a shift register. The horizontal drive circuit 103 sequentially selects each column signal processing circuit 105 by sequentially outputting a horizontal scanning pulse to cause each column signal processing circuit 105 to output the pixel signal to the output circuit 106 through the horizontal signal line 123.

The control circuit 104 controls the entire solid-state imaging device 100. The control circuit 104 receives an input clock and data instructing an operation mode and the like, and outputs data such as internal information regarding the solid-state imaging device 100. For example, the control circuit 104 generates, on the basis of a vertical synchronization signal, a horizontal synchronization signal, and a master clock, a clock and a control signal in accordance with which the vertical drive circuit 102, the horizontal drive circuit 103, the column signal processing circuit 105, and the like operate. The control signal may include designation information specifying the driver 113 that is selected when driving the pixels 111. At this time, an address unique to each driver 113 may be assigned to each driver 113. At this time, the control circuit 104 may use the address unique to each driver 113 as the designation information specifying the driver 113. Furthermore, the control circuit 104 may simultaneously designate a plurality of drivers 113. For example, in a case where tens of thousands of drivers 113 are provided in the solid-state imaging device 100, the control circuit 104 may simultaneously designate hundreds of drivers 113. Then, the control circuit 104 inputs such signals to the vertical drive circuit 102, the horizontal drive circuit 103, the column signal processing circuit 105, and the like.

The column signal processing circuit 105 is arranged, for example, for each column of the pixel array unit 101. The column signal processing circuit 105 performs signal processing such as noise removal for each column on the signals output from the pixels 111 of one row. For example, the column signal processing circuit 105 performs signal processing such as correlated double sampling (CDS) for removing fixed pattern noise specific to each pixel 111, signal amplification, and analog to digital (AD) conversion. A horizontal selection switch (not illustrated) is connected between an output stage of the column signal processing circuit 105 and the horizontal signal line 123.

The output circuit 106 performs signal processing on the signals sequentially supplied from each column signal processing circuit 105 through the horizontal signal line 123, and outputs the processed signals. For example, the output circuit 106 may perform buffering, black level adjustment, column variation correction, various digital signal processing, or the like on the signals supplied from the column signal processing circuit 105.

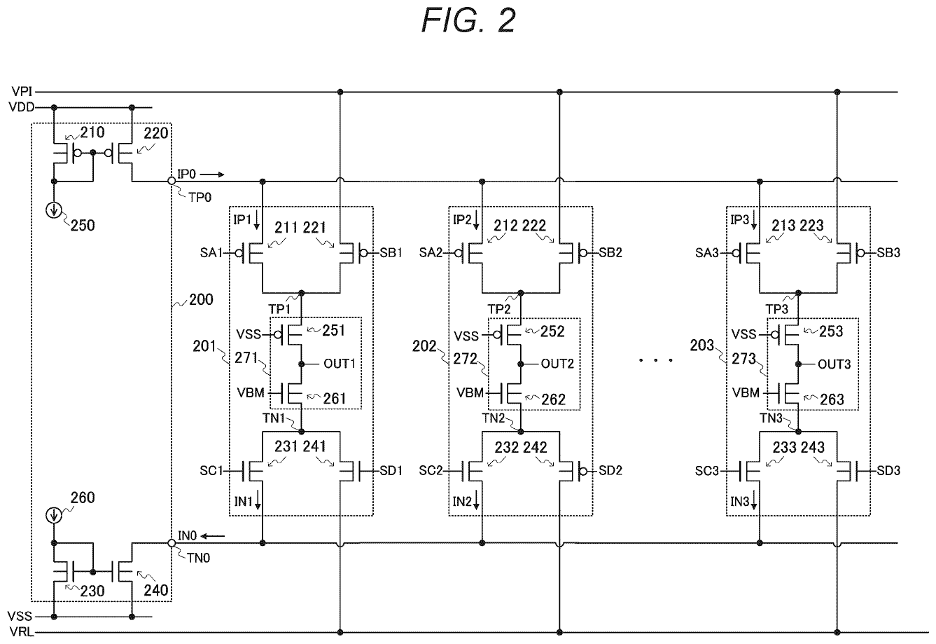

FIG. 2 is a circuit diagram illustrating a configuration example of a driver circuit according to the first embodiment.

In the drawing, the driver circuit includes a current source 200 and drivers 201 to 203. The current source 200 and the drivers 201 to 203 may be used as the current source 112 and the driver 113 in FIG. 1, respectively. Note that the drawing illustrates an example where the three drivers 201 to 203 are provided, but it is only required that at least two drivers be provided.

The current source 200 can be shared by the plurality of drivers 201 to 203. At this time, the drivers 201 to 203 are connected in parallel to the current source 200. The current source 200 generates a mirror current on the basis of current mirror operation, and outputs the mirror current as currents IP0 and IN0. The current source 200 includes PMOS transistors 210 and 220, NMOS transistors 230 and 240, and current sources 250 and 260.

A power supply voltage VDD is applied to a source of each of the PMOS transistors 210 and 220, and each of the PMOS transistors 210 and 220 has a gate connected to a drain of the PMOS transistor 210. The PMOS transistor 220 has a drain connected to a current terminal TP0.

A ground voltage VSS is applied to a source of each of the NMOS transistors 230 and 240, and each of the NMOS transistors 230 and 240 has a gate connected to a drain of the NMOS transistor 230. The NMOS transistor 240 has a drain connected to a current terminal TN0.

The current source 250 draws a reference current from the drain of the PMOS transistor 210, and the current source 260 draws a reference current into the drain of the NMOS transistor 230. The reference current drawn from the drain of the PMOS transistor 210 and the reference current drawn into the drain of the NMOS transistor 230 can be equal to each other.

The drivers 201 to 203 are driven with divided currents IP1 to IP3 and IN1 to IN3 resulting from dividing the currents IP0 and IN0 generated by the current source 200, respectively, and generate transistor drive signals OUT1 to OUT3, respectively. At this time, the driver 201 is driven and controlled on the basis of switching signals SA1, SB1, SC1, and SD1. The driver 202 is driven and controlled on the basis of switching signals SA2, SB2, SC2, and SD2. The driver 203 is driven and controlled on the basis of switching signals SA3, SB3, SC3, and SD3.

The driver 201 includes PMOS transistors 211 and 221, NMOS transistors 231 and 241, and a withstand voltage protection circuit 271. The withstand voltage protection circuit 271 protects the transistors from overvoltage exceeding the withstand voltage of the transistors of the driver 201. The withstand voltage protection circuit 271 includes a PMOS transistor 251 and an NMOS transistor 261.

The PMOS transistor 211 has a source connected to the current terminal TP0, a step-up voltage VPI is applied to a source of the PMOS transistor 221, and each of the PMOS transistors 211 and 221 has a drain connected to an output terminal TP1. The step-up voltage VPI is a voltage resulting from stepping up the power supply voltage VDD.

The NMOS transistor 231 has a source connected to the current terminal TN0, a step-down voltage VRL is applied to a source of the NMOS transistor 241, and each of the NMOS transistors 231 and 241 has a drain connected to the output terminal TN1. The step-down voltage VRL is a voltage resulting from stepping down the ground voltage VSS.

The PMOS transistor 251 and the NMOS transistor 261 are connected in series with each other, and this series circuit is connected between the output terminal TP1 and the output terminal TN1. The drive signal OUT1 is output from the output terminal TP1 via the PMOS transistor 251, and the drive signal OUT1 is output from the output terminal TN1 via the NMOS transistor 261.

The switching signal SA1 is applied to a gate of the PMOS transistor 211, the switching signal SB1 is applied to a gate of the PMOS transistor 221, the switching signal SC1 is applied to a gate of the NMOS transistor 231, and the switching signal SD1 is applied to a gate of the NMOS transistor 241. The ground voltage VSS is applied to a gate of the PMOS transistor 251, and a protection bias VBM is applied to a gate of the NMOS transistor 261. The protection bias VBM can be set to match the withstand voltage of the transistors of each of the drivers 201 to 203.

The driver 202 includes PMOS transistors 212 and 222, NMOS transistors 232 and 242, and a withstand voltage protection circuit 272. The withstand voltage protection circuit 272 protects the transistors from overvoltage exceeding the withstand voltage of the transistors of the driver 202. The withstand voltage protection circuit 272 includes a PMOS transistor 252 and an NMOS transistor 262.

The PMOS transistor 212 has a source connected to the current terminal TP0, the step-up voltage VPI is applied to a source of the PMOS transistor 222, and each of the PMOS transistors 212 and 222 has a drain connected to an output terminal TP2.

The NMOS transistor 232 has a source connected to the current terminal TN0, the step-down voltage VRL is applied to a source of the NMOS transistor 242, and each of the NMOS transistors 232 and 242 has a drain connected to an output terminal TN2.

The PMOS transistor 252 and the NMOS transistor 262 are connected in series with each other, and this series circuit is connected between the output terminal TP2 and the output terminal TN2. The drive signal OUT2 is output from the output terminal TP2 via the PMOS transistor 252, and the drive signal OUT2 is output from the output terminal TN2 via the NMOS transistor 262.

The switching signal SA2 is applied to a gate of the PMOS transistor 212, the switching signal SB2 is applied to a gate of the PMOS transistor 222, the switching signal SC2 is applied to a gate of the NMOS transistor 232, and the switching signal SD2 is applied to a gate of the NMOS transistor 242. The ground voltage VSS is applied to a gate of the PMOS transistor 252, and the protection bias VBM is applied to a gate of the NMOS transistor 262.

The driver 203 includes PMOS transistors 213 and 223, NMOS transistors 233 and 243, and a withstand voltage protection circuit 273. The withstand voltage protection circuit 273 protects the transistors from overvoltage exceeding the withstand voltage of the transistors of the driver 203. The withstand voltage protection circuit 273 includes a PMOS transistor 253 and an NMOS transistor 263.

The PMOS transistor 213 has a source connected to the current terminal TP0, the step-up voltage VPI is applied to a source of the PMOS transistor 223, and each of the PMOS transistors 213 and 223 has a drain connected to an output terminal TP3.

The NMOS transistor 233 has a source connected to the current terminal TN0, the step-down voltage VRL is applied to a source of the NMOS transistor 243, and each of the NMOS transistors 233 and 243 has a drain connected to an output terminal TN3.

The PMOS transistor 253 and the NMOS transistor 263 are connected in series with each other, and this series circuit is connected between the output terminal TP3 and the output terminal TN3. The drive signal OUT3 is output from the output terminal TP3 via the PMOS transistor 253, and the drive signal OUT3 is output from the output terminal TN3 via the NMOS transistor 263.

The switching signal SA3 is applied to a gate of the PMOS transistor 213, the switching signal SB3 is applied to a gate of the PMOS transistor 223, the switching signal SC3 is applied to a gate of the NMOS transistor 233, and the switching signal SD3 is applied to a gate of the NMOS transistor 243. The ground voltage VSS is applied to a gate of the PMOS transistor 253, and the protection bias VBM is applied to a gate of the NMOS transistor 263.

In the driver 201, the switching signals SA1, SB1, SC1, and SD1 are set to turn on the PMOS transistor 211, the PMOS transistor 221, the NMOS transistor 231, and the NMOS transistor 241 in this order. In the driver 202, the switching signals SA2, SB2, SC2, and SD2 are set to turn on the PMOS transistor 212, the PMOS transistor 222, the NMOS transistor 232, and the NMOS transistor 242 in this order. In the driver 203, the switching signals SA3, SB3, SC3, and SD3 are set to turn on the PMOS transistor 213, the PMOS transistor 223, the NMOS transistor 233, and the NMOS transistor 243 in this order.

Here, it is assumed that the drivers 201 to 203 are simultaneously put into operation. At this time, the switching signals SA1 to SA3 can simultaneously turn on the PMOS transistors 211 to 213, and then the switching signals SB1 to SB3 can simultaneously turn on the PMOS transistors 221 to 223. Furthermore, the switching signals SC1 to SC3 can simultaneously turn on the NMOS transistors 231 to 233, and then the switching signals SD1 to SD3 can simultaneously turn on the NMOS transistors 241 to 243.

For example, at the rising edge of the drive signals OUT1 to OUT3, the PMOS transistors 211 to 213 are turned on on the basis of the switching signals SA1 to SA3, respectively. At this time, the PMOS transistors 211 to 213 are current-driven, respectively, on the basis of the divided currents IP1 to IP3 resulting from dividing the current IP0 generated by the current source 200. Then, the drive signals OUT1 to OUT3 are output via the output terminals TP1 to TP3, respectively, for precharging from the step-down voltage VRL in the initial state to the power supply voltage VDD. Once precharging is performed until the power supply voltage VDD is reached, the PMOS transistors 221 to 223 are turned on on the basis of the switching signals SB1 to SB3, respectively. At this time, each of the PMOS transistors 221 to 223 is voltage-driven on the basis of the step-up voltage VPI. Then, the drive signals OUT1 to OUT3 are output via the output terminals TP1 to TP3, respectively, and settling from the power supply voltage VDD to the step-up voltage VPI is performed.

At the falling edge of the drive signals OUT1 to OUT3, the NMOS transistors 231 to 233 are turned on on the basis of the switching signals SC1 to SC3, respectively. At this time, the NMOS transistors 231 to 233 are current-driven, respectively, on the basis of the divided currents IN1 to IN3 resulting from dividing the current IN0 generated by the current source 200. Then, the drive signals OUT to OUT3 are output via the output terminals TN1 to TN3, respectively, to cause discharging from the step-up voltage VPI to the ground potential VSS. Once discharging is made to the ground potential VSS, the NMOS transistors 241 to 243 are turned on on the basis of the switching signals SD1 to SD3, respectively. At this time, each of the NMOS transistors 241 to 243 is voltage-driven on the basis of the step-down voltage VRL. Then, the drive signals OUT1 to OUT3 are output via the output terminals TN1 to TN3, respectively, to cause discharging from the ground potential VSS to the step-down voltage VRL.

Note that the current source 200 is an example of the current generation unit described in the claims. Each of the drivers 201 to 203 is an example of the current-driven unit described in the claims. The PMOS transistors 211 to 213 and the NMOS transistors 231 to 233 are examples of the current-driven unit described in the claims. The PMOS transistors 221 to 223 and the NMOS transistors 241 to 243 are examples of a voltage-driven unit described in the claims.

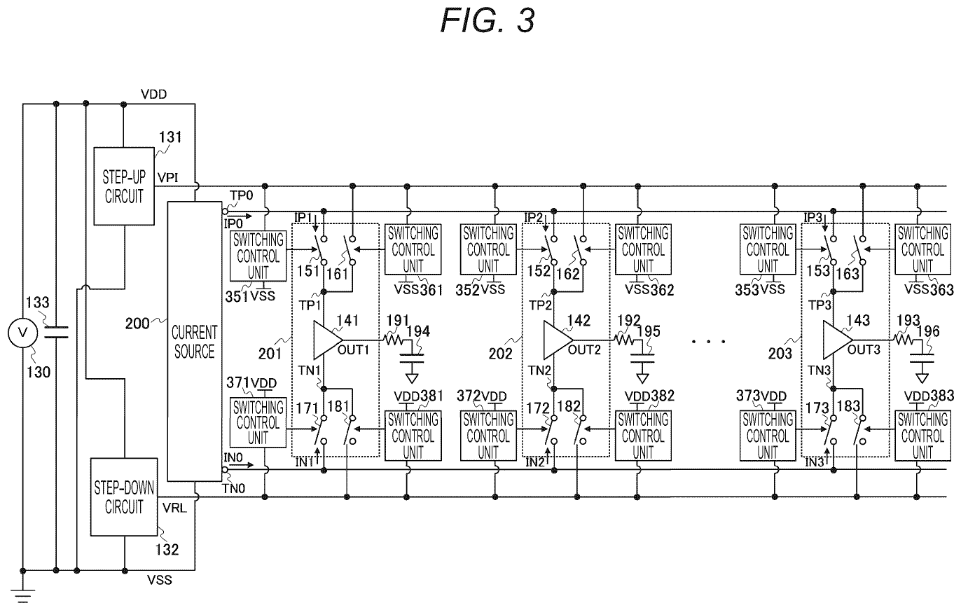

FIG. 3 is a block diagram illustrating a configuration example of a switching control unit and a power supply of the driver circuit according to the first embodiment.

In the drawing, the driver circuit includes a step-up circuit 131, a step-down circuit 132, the current source 200, the drivers 201 to 203, and switching control units 351 to 353, 361 to 363, 371 to 373, and 381 to 383.

The step-up circuit 131, the step-down circuit 132, and the current source 200 are connected to a power supply 130. The power supply 130 supplies the power supply voltage VDD to the step-up circuit 131, the step-down circuit 132, and the current source 200. A capacitor 133 is connected in parallel to the power supply 130. The capacitor 133 can supply a steep current flowing through the current source 200.

The step-up circuit 131 generates the step-up voltage VPI resulting from stepping up the power supply voltage VDD and supplies the step-up voltage VPI to each of the drivers 201 to 203. The step-down circuit 132 generates the step-down voltage VRL resulting from stepping down the ground voltage VSS and supplies the step-down voltage VRL to each of the drivers 201 to 203. For example, when the power supply voltage VDD is 2.8 V, the step-up voltage VPI can be 3 V, and the step-down voltage VRL can be −1.2 V.

The current source 200 includes the current terminals TP0 and TN0. The power supply voltage VDD and the ground voltage VSS are supplied to the current source 200. Then, the current source 200 generates the currents IP0 and IMN, outputs the current IP0 via the current terminal TP0, and draws the current IN0 via the current terminal TN0. Here, the current IP0 output from the current terminal TP0 is divided into the divided currents IP1 to IP3, and the divided currents IP1 to IP3 are input to the drivers 201 to 203, respectively. The current IN0 drawn via the current terminal TN0 is divided into the divided currents IN1 to IN3, and the divided currents IN1 to IN3 are drawn from the drivers 201 to 203, respectively.

The driver 201 includes switching elements 151, 161, 171, and 181 and a withstand voltage protection circuit 141. Note that, as the switching elements 151, 161, 171, and 181, the PMOS transistors 211 and 221 and the NMOS transistors 231 and 241 in FIG. 2 may be used, respectively. As the withstand voltage protection circuit 141, the withstand voltage protection circuit 271 in FIG. 2 may be used.

The driver 202 includes switching elements 152, 162, 172, and 182 and a withstand voltage protection circuit 142. Note that, as the switching elements 152, 162, 172, and 182, the PMOS transistors 212 and 222 and the NMOS transistors 232 and 242 in FIG. 2 may be used, respectively. As the withstand voltage protection circuit 142, the withstand voltage protection circuit 272 in FIG. 2 may be used.

The driver 203 includes switching elements 153, 163, 173, and 183 and a withstand voltage protection circuit 143. Note that, as the switching elements 153, 163, 173, and 183, the PMOS transistors 213 and 223 and the NMOS transistors 233 and 243 in FIG. 2 may be used, respectively. As the withstand voltage protection circuit 143, the withstand voltage protection circuit 273 in FIG. 2 may be used.

The switching elements 151 to 153 and 171 to 173 are examples of the current-driven unit described in the claims. The switching elements 161 to 163 and 181 to 183 are examples of the voltage-driven unit described in the claims.

The withstand voltage protection circuit 141 protects the switching elements 151, 161, 171, and 181 from overvoltage exceeding the withstand voltage of each of the switching elements 151, 161, 171, and 181. The withstand voltage protection circuit 142 protects the switching elements 152, 162, 172, and 182 from overvoltage exceeding the withstand voltage of each of the switching elements 152, 162, 172, and 182. The withstand voltage protection circuit 143 protects the switching elements 153, 163, 173, and 183 from overvoltage exceeding the withstand voltage of each of the switching elements 153, 163, 173, and 183.

Each of the switching elements 151 and 161 has one end connected to the output terminal TP1, each of the switching elements 152 and 162 has one end connected to the output terminal TP2, and each of the switching elements 153 and 163 has one end connected to the output terminal TP3. Each of the switching elements 171 and 181 has one end connected to the output terminal TN1, each of the switching elements 172 and 182 has one end connected to the output terminal TN2, and each of the switching elements 173 and 183 has one end connected to the output terminal TN3.

The drive signal OUT1 for the pixels 111 is output from each of the output terminals TP1 and TN1 via the withstand voltage protection circuit 141. The drive signal OUT1 is distributed to each pixel 111 on the corresponding line. Here, total interconnect resistance 191 and total parasitic capacitance 194 of the line to which the drive signal OUT1 is output are represented equivalently.

The drive signal OUT2 for the pixels 111 is output from each of the output terminals TP2 and TN2 via the withstand voltage protection circuit 142. The drive signal OUT2 is distributed to each pixel 111 on the corresponding line. Here, total interconnect resistance 192 and total parasitic capacitance 195 of the line to which the drive signal OUT2 is output are represented equivalently.

The drive signal OUT3 for the pixels 111 is output from each of the output terminals TP3 and TN3 via the withstand voltage protection circuit 143. The drive signal OUT3 is distributed to each pixel 111 on the corresponding line. Here, total interconnect resistance 193 and total parasitic capacitance 196 of the line to which the drive signal OUT3 is output are represented equivalently.

Each of the switching elements 151 and 153 has the other end connected to the current terminal TP0, and each of the switching elements 171 and 173 has the other end connected to the current terminal TN0. The step-up voltage VPI is supplied to the other end of each of the switching elements 161 to 163, and the step-down voltage VRL is supplied to the other end of each of the switching elements 181 to 183.

At the rising edge of the drive signal OUT1, one of the switching elements 151 and 161 exclusively supplies the drive signal OUT1 to the output terminal TP1. At the rising edge of the drive signal OUT2, one of the switching elements 152 and 162 exclusively supplies the drive signal OUT2 to the output terminal TP2. At the rising edge of the drive signal OUT3, one of the switching elements 153 and 163 exclusively supplies the drive signal OUT3 to the output terminal TP3. At this time, each of the drivers 201 to 203 can select current drive based on the divided currents IP1 to IP3 until the power supply voltage VDD is reached, and then select voltage drive based on the step-up voltage VPI until the step-up voltage VPI is reached.

At the falling edge of the drive signal OUT1, one of the switching elements 171 and 181 exclusively supplies the drive signal OUT1 to the output terminal TN1. At the falling edge of the drive signal OUT2, one of the switching elements 172 and 172 exclusively supplies the drive signal OUT2 to the output terminal TN2. At the falling edge of the drive signal OUT3, one of the switching elements 173 and 183 exclusively supplies the drive signal OUT3 to the output terminal TN3. At this time, each of the drivers 201 to 203 can select current drive based on the divided currents IN1 to IN3 until the ground voltage VSS is reached, and then select voltage drive based on the step-down voltage VRL until the step-down voltage VRL is reached.

The drivers 201 to 203 can turn on, on the basis of the control signal, the switching elements 151 to 153, the switching elements 161 to 163, the switching elements 171 to 173, and the switching elements 181 to 183 in this order.

At this time, at the rising edge of the drive signals OUT1 to OUT3, the switching elements 151 to 153 are respectively turned on for precharging from the step-down voltage VRL in the initial state to the power supply voltage VDD. Once precharging is performed until the power supply voltage VDD is reached, each of the switching elements 161 to 163 is turned on, and settling from the power supply voltage VDD to the step-up voltage VPI is performed. That is, it is possible to perform precharging using the current source 200 until the power supply voltage VDD is reached and then perform settling using the step-up circuit 131 until the step-up voltage VPI is reached.

At this time, at the falling edge of the drive signals OUT1 to OUT3, the switching elements 171 to 173 are respectively turned on for discharging from the step-up voltage VPI to the ground potential VSS. Once discharging is performed until the ground potential VSS is reached, each of the switching elements 181 to 183 is turned on for discharging from the ground potential VSS to the step-down voltage VRL. That is, it is possible to perform discharging using the current source 200 until the ground potential VSS is reached and then perform discharging using the step-down circuit 132 until the step-down voltage VRL is reached.

The switching control units 351, 361, 371, and 381 controls switching of the switching elements 151, 161, 171, and 181, respectively. At this time, the switching control units 351, 361, 371, and 381 can turn on the switching element 151, the switching element 161, the switching element 171, and the switching element 181 in this order.

The switching control units 352, 362, 372, and 382 controls switching of the switching elements 152, 162, 172, and 182, respectively. At this time, the switching control units 352, 362, 372, and 382 can turn on the switching element 152, the switching element 162, the switching element 172, and the switching element 182 in this order.

The switching control units 353, 363, 373, and 383 controls switching of the switching elements 153, 163, 173, and 183, respectively. At this time, the switching control units 353, 363, 373, and 383 can turn on the switching element 153, the switching element 163, the switching element 173, and the switching element 183 in this order.

Here, it is assumed that the drivers 201 to 203 are simultaneously put into operation. At this time, the switching control units 351 to 353, 361 to 363, 371 to 373, and 381 to 383 can perform cooperative control to synchronously turn on the switching elements 151 to 153, the switching elements 161 to 163, the switching elements 171 to 173, the switching elements 181 to 183 in this order.

Furthermore, each of the switching control units 351 to 353 and 361 to 363 can operate as a step-up level shifter. Since the step-up voltage VPI is applied to each of the drivers 201 to 203, each of the switching control units 351 to 353 and 361 to 363 can control the generation of the control signal for a corresponding one of the drivers 201 to 203 via the step-up level shifter. Furthermore, each of the switching control units 371 to 373 and 381 to 383 can operate as a step-down level shifter. Since the step-down voltage VRL is applied to each of the drivers 201 to 203, each of the switching control units 371 to 373 and 381 to 383 can control the generation of the control signal for a corresponding one of the drivers 201 to 203 via the step-down level shifter.

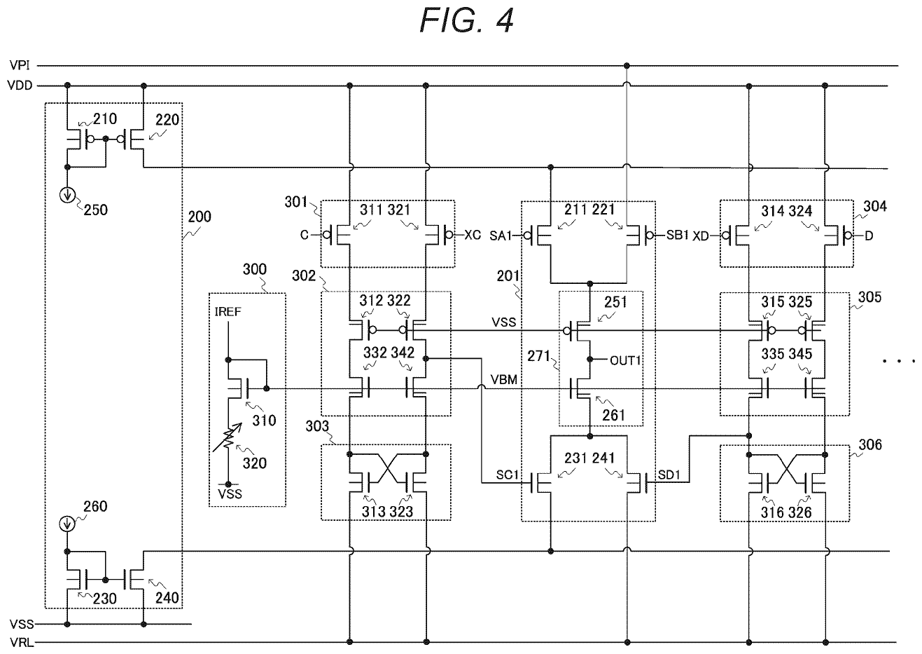

FIG. 4 is a circuit diagram illustrating a configuration example of the switching control unit of the driver circuit according to the first embodiment. Note that FIG. 4 illustrates the current source 200, the driver 201, and the switching control units 371 and 381 extracted from FIG. 3. FIG. 4 further illustrates a withstand voltage protection bias circuit 300 that generates the protection bias VBM.

The withstand voltage protection bias circuit 300 includes an NMOS transistor 310 and a variable resistor 320. The variable resistor 320 can be used as a trimming resistor. A current IREF is input to a drain of the NMOS transistor 310. The NMOS transistor 310 has a gate connected to the drain of the NMOS transistor 310, and the ground voltage VSS is applied to a source of the NMOS transistor 310 via the variable resistor 320.

The switching control unit 371 includes an amplitude control unit 301, a withstand voltage protection circuit 302, and a level shifter 303. The amplitude control unit 301 includes PMOS transistors 311 and 321. The withstand voltage protection circuit 302 includes PMOS transistors 312 and 322 and NMOS transistors 332 and 342. The level shifter 303 includes NMOS transistors 313 and 323.

The switching control unit 381 includes an amplitude control unit 304, a withstand voltage protection circuit 305, and a level shifter 306. The amplitude control unit 304 includes PMOS transistors 314 and 324. The withstand voltage protection circuit 305 includes PMOS transistors 315 and 325 and NMOS transistors 335 and 345. The level shifter 306 includes NMOS transistors 316 and 326.

The PMOS transistor 311, the PMOS transistor 312, the NMOS transistor 332, and the NMOS transistor 313 are connected in series in this order. The PMOS transistor 321, the PMOS transistor 322, the NMOS transistor 342, and the NMOS transistor 323 are connected in series in this order. The PMOS transistor 314, the PMOS transistor 315, the NMOS transistor 335, and the NMOS transistor 316 are connected in series in this order. The PMOS transistor 324, the PMOS transistor 325, the NMOS transistor 345, and the NMOS transistor 326 are connected in series in this order.

The power supply voltage VDD is applied to a source of each of the PMOS transistor 311, 321, 314, and 324. The step-down voltage VRL is applied to a source of each of the NMOS transistors 313, 323, 316, and 326. The NMOS transistor 231 has a gate connected to a connection point between the PMOS transistor 322 and the NMOS transistor 342. The NMOS transistor 241 has a gate connected to a connection point between the NMOS transistors 316 and 335. The NMOS transistor 313 has a gate connected to a drain of the NMOS transistor 323. The NMOS transistor 323 has a gate connected to a drain of the NMOS transistor 313. The NMOS transistor 316 has a gate connected to a drain of the NMOS transistor 326. The NMOS transistor 326 has a gate connected to a drain of the NMOS transistor 316.

Each of the NMOS transistors 261, 332, 342, 335, and 345 has a gate connected to a gate of the NMOS transistor 310. At this time, the NMOS transistor 310, the NMOS transistors 261, 332, 342, 335, and 345 can constitute a current mirror circuit, and can compensate for process voltage temperature (PVT) variations.

The ground voltage VSS is applied to a gate of each PMOS transistor 251, 312, 322, 315, and 325. A selection signal C is applied to a gate of the PMOS transistor 311, and an inverted selection signal XC is applied to a gate of the PMOS transistor 321. The inverted selection signal XC is a signal resulting from inverting the selection signal C. A selection signal D is applied to a gate of the PMOS transistor 324, and an inverted selection signal XD is applied to a gate of the PMOS transistor 314. The inverted selection signal XD is a signal resulting from inverting the selection signal D.

At this time, the switching signals SC1 and SD1 are generated on the basis of the selection signals C and D and are input to the gates of the NMOS transistors 231 and 241, respectively. Here, the PMOS transistors 311 and 321 operate as level shifters that control the amplitude of the NMOS transistor 231, and the PMOS transistors 314 and 324 operate as level shifters that control the amplitude of the NMOS transistor 241.

The drive signal OUT1 has an amplitude of 4.2 V(=VPI−VRL) in the above-described example. On the other hand, the withstand voltage of the transistors of the driver 201 is assumed to be 3 V.

A voltage dV across the variable resistor 320 is determined by the product a resistance value R1 of the variable resistor 320 and the current IREF. Therefore, assuming that the gate-source voltage of the NMOS transistor 310 is Vgs, the protection bias VBM output from the withstand voltage protection bias circuit 300 becomes dV+Vgs. Assuming that the withstand voltage of the transistors of the driver 201 is 3.0 V, the variable resistor 320 performs trimming to satisfy:

dV+Vgs−Vgs−VRL=dV−VRL<3.0 V.

It is therefore possible to make design to match the withstand voltage of the transistors of the driver 201.

The NMOS transistors 313 and 323 operate as negative level shifters, and the NMOS transistors 316 and 326 operate as negative level shifters. Here, since the NMOS transistors 231 and 241 are controlled by the step-down voltage VRL resulting from stepping down the ground voltage VSS, the generation of the switching signals SC1 and SD1 is controlled via these negative level shifters.

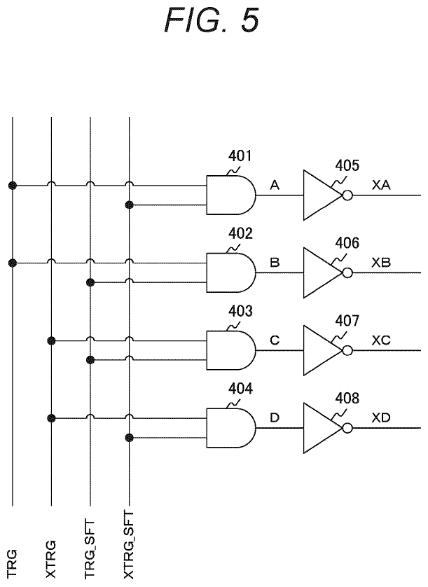

FIG. 5 is a circuit diagram illustrating a configuration example of a logic circuit used to generate the control signal for the driver circuit according to the first embodiment.

In the drawing, the logic circuit can generate selection signals A, B, C, and D on the basis of a trigger signal TRG and output inverted selection signals XA, XB, XC, and XD resulting from inverting the selection signals A, B, C, and D. Here, the selection signals A, B, C, and D can rise in the order of A, B, C, and D. Furthermore, the selection signal B can rise at the falling edge of the selection signal A, the selection signal C can rise at the falling edge of the selection signal B, the selection signal D can rise at the falling edge of the selection signal C, and the selection signal A can rise at the falling edge of the selection signal D. At this time, the switching control units 351, 361, 371, and 381 can synchronize the rising and falling timing of the switching signals SA1, SB1, SC1, and SD1 with the rising and falling timing of the inverted selection signals XA, XB, XC, and XD.

The logic circuit includes AND circuits 401 to 404 and inverters 405 to 408. The inverters 405 to 408 are connected to subsequent stages of the AND circuits 401 to 404, respectively.

The AND circuit 401 performs an AND operation on the trigger signal TRG and a shift trigger inverted signal XTRG SFT to generate the selection signal A, and inputs the selection signal A to the inverter 405. The inverter 405 inverts the selection signal A to generate the inverted selection signal XA.

The AND circuit 402 performs an AND operation on the trigger signal TRG and a shift trigger signal TRG SFT to generate the selection signal B, and inputs the selection signal B to the inverter 406. The inverter 406 inverts the selection signal B to generate the inverted selection signal XB.

The AND circuit 403 performs an AND operation on a trigger inverted signal XTRG and the shift trigger signal TRG SFT to generate the selection signal C, and inputs the selection signal C to the inverter 407. The inverter 407 inverts the selection signal C to generate the inverted selection signal XC.

The AND circuit 404 performs an AND operation on the trigger inverted signal XTRG and the shift trigger inverted signal XTRG SFT to generate the selection signal D, and inputs the selection signal D to the inverter 408. The inverter 408 inverts the selection signal D to generate the inverted selection signal XD.

The trigger inverted signal XTRG is a signal resulting from inverting the trigger signal TRG. The shift trigger signal TRG SFT is a signal resulting from shifting the trigger signal TRG. The shift amount of the shift trigger signal TRG SFT can be made proportional to, for example, the ON time of the PMOS transistor 211 and the NMOS transistor 231. The shift trigger inverted signal XTRG SFT is a signal resulting from inverting the shift trigger signal TRG SFT.

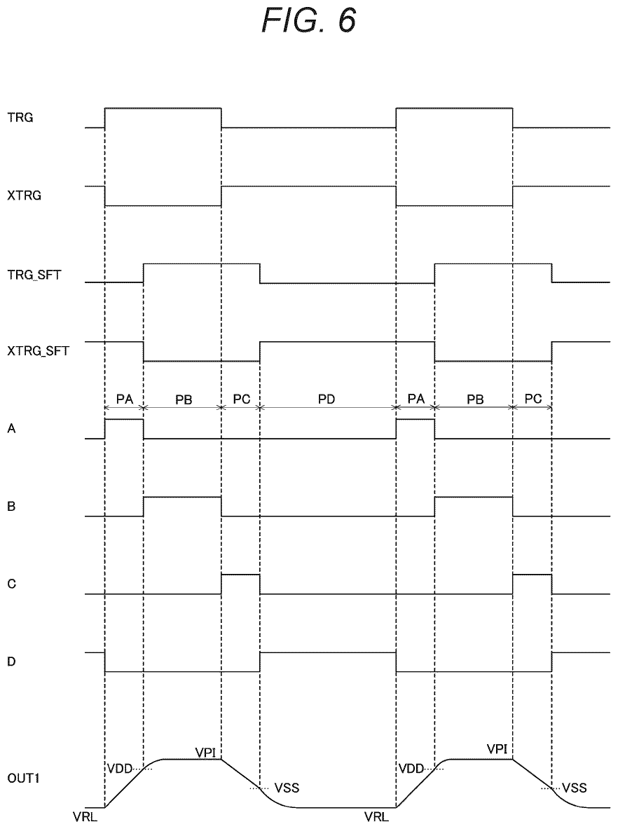

FIG. 6 is a timing chart illustrating how the driver circuit according to the first embodiment operates. Note that, in the following description, the operation of the driver 201 in FIG. 2 is taken as an example.

In the drawing, the selection signals A, B, C, and D repeat active periods PA, PB, PC, and PD in the order of A, B, C, and D. The active period is a period during which the selection signals A, B, C, and D are at a high level.

During the active period PA, the PMOS transistor 211 is on, and charging is performed to change the drive signal OUT1 from the step-down voltage VRL to the power supply voltage VDD. The active period PA is a precharging period. During the active period PB, the PMOS transistor 221 is on, and charging is performed to change the drive signal OUT1 from the power supply voltage VDD to the step-up voltage VPI.

During the active period PC, the NMOS transistor 231 is on, and discharging is performed to change the drive signal OUT1 from the step-up voltage VPI to the ground voltage VSS. The active period PC is a predischarging period. During the active period PD, the NMOS transistor 241 is on, and discharging is performed to change the drive signal OUT1 from the ground voltage VSS to the step-down voltage VRL.

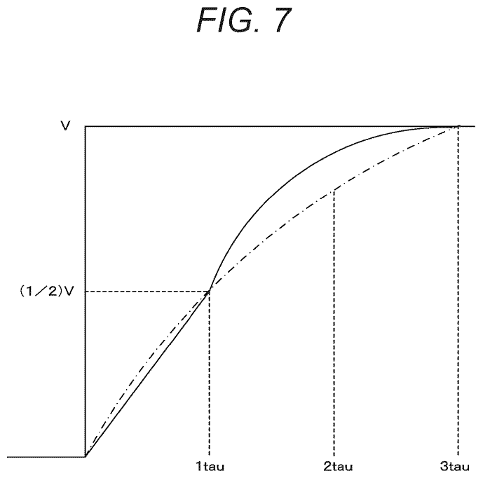

FIG. 7 is a diagram illustrating an example of a slew rate of the driver circuit according to the first embodiment. Note that a chain line indicates a waveform in a case where the operation is performed as a voltage driver using the step-up circuit 131 or the step-down circuit 132 from the beginning. A solid line indicates a waveform in a case where after operating as a current driver to perform the precharging operation up to 0.63 times the target voltage V, switching to the voltage driver is made.

In the drawing, in a case where the operation is performed as the voltage driver using the step-up circuit 131 or the step-down circuit 132 from the beginning, the voltage increases in a curved manner due to a time constant tau (0.63 times) from the beginning.

On the other hand, in a case where after operating as the current driver to perform the precharging operation up to 0.63 times the target voltage V, switching to the voltage driver is made, the voltage increases linearly due to the current driver at the beginning, and then increases in a curved manner due to the time constant tau. Since 0.63 of the required charge amount is precharged as the current driver, a charge amount to be supplied from the step-up circuit 131 and the step-down circuit 132 when operating as the voltage driver only needs to be 0.63.

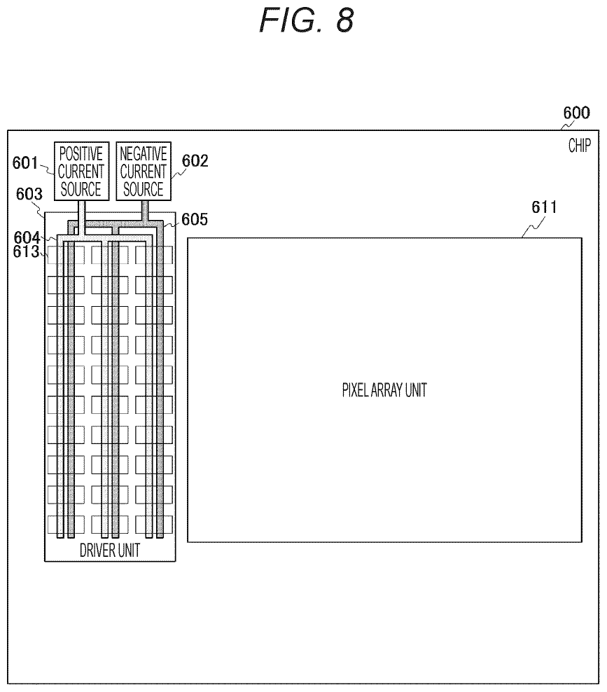

FIG. 8 is a diagram illustrating an example of a layout of wirings used to current-drive the driver circuit according to the first embodiment.

In the drawing, a positive current source 601, a negative current source 602, a driver unit 603, and a pixel array unit 611 are formed on a chip 600. On the chip 600, the horizontal drive circuit 103, the control circuit 104, the column signal processing circuit 105, and the output circuit 106 in FIG. 1 may be formed.

The material of the chip 600 may be Si, InP, InGaAs, GaAs, SiC, or GaN.

The positive current source 601 generates a current to be input to the driver unit 603. The positive current source 601 generates, for example, the current IP0 in FIG. 2. At this time, the positive current source 601 can be provided with the PMOS transistors 210 and 220. The negative current source 602 generates a current to be drawn from the driver unit 603. The negative current source 602 generates, for example, the current IN0 in FIG. 2. At this time, the negative current source 602 can be provided with the NMOS transistors 230 and 240. The positive current source 601 and the negative current source 602 can be used as the current source 112 in FIG. 1.

The driver unit 603 includes a plurality of drivers 613. The drivers 613 can be arranged in a plurality of rows. FIG. 8 illustrates an example where the drivers 613 are arranged in three rows. As each driver 613, the driver 201 in FIG. 2 may be used. At this time, each driver 613 can be provided with the PMOS transistors 211 and 221 and the NMOS transistors 231 and 241. As each driver 613, the driver 113 in FIG. 1 may be used.

Each driver 613 is connected to the positive current source 601 via a wiring 604 and is connected to the negative current source 602 via a wiring 605. The positive current source 601 can output the current IP0 to the driver unit 603 via the wiring 604, and the negative current source 602 can draw the current IN0 from the driver unit 603 via the wiring 605.

Each of the wirings 604 and 605 can be made larger in width than a wiring through which the control signal is transmitted to the driver unit 603. The width of each of the wirings 604 and 605 can be set to allow a maximum current of about 100 mA to flow while the driver unit 603 is in operation. Each of the wirings 604 and 605 may be equal in width to a power supply line formed on the chip 600.

Note that, although FIG. 8 illustrates an example where the pixel array unit 611 and the driver unit 603 are formed on the same chip 600, the pixel array unit 611 and the driver unit 603 may be formed on separate chips. At this time, the chip on which the pixel array unit 611 is formed and the chip on which the driver unit 603 is formed may be stacked together. The wiring of the pixel array unit 611 and the wiring of the driver unit 603 may be connected by hybrid bonding including Cu-Cu bonding, for example.

As described above, in the first embodiment described above, the plurality of drivers 201 to 203 can be current-driven on the basis of the currents IP0 and IN0 generated by the current source 200. Here, even when the divided currents IP1 to IP3 resulting from dividing the current IP0 generated by the current source 200 flow through the PMOS transistors 211 to 213, there is no impact on variations in the gate-to-source voltage Vgs of each of the PMOS transistors 211 to 213. Furthermore, even when the divided currents IN1 to IN3 resulting from dividing the current IN0 generated by the current source 200 flow through the NMOS transistors 231 to 233, there is no impact on variations in the gate-source voltage Vgs of each of the NMOS transistors 231 to 233. It is therefore possible to eliminate non-uniformity of driving of the pixels 111 caused by IR drop in the power supply voltage VDD while the plurality of drivers 201 to 203 is in operation.

Furthermore, the current source 200 can be shared by the plurality of drivers 201 to 203, which eliminates the need of providing the current source 200 for each of the drivers 201 to 203. It is therefore possible to reduce an installation area of the current source 200 that current-drives the drivers 201 to 203, and it is possible to reduce a leakage current. For example, it is possible to reduce power consumption caused by a leakage current at the time of software standby of multi-camera controlled by an application processor.

Moreover, the current used to drive the plurality of drivers 201 to 203 can be generated by one current source 200. It is therefore possible to suppress variations in current caused by variations in characteristics of the PMOS transistors 211 to 213 and the NMOS transistors 231 to 233, and it is possible to make the slew rates of the drivers 201 to 203 uniform.

### 2. Second Embodiment

In the first embodiment described above, the plurality of drivers 201 to 203 is driven on the basis of the currents IP0 and IN0 generated by the current source 200. In this second embodiment, the number of drivers to be simultaneously driven is extracted from the control signal for controlling the driver unit, and the current generated by the current source is controlled according to the number of drivers to be simultaneously driven.

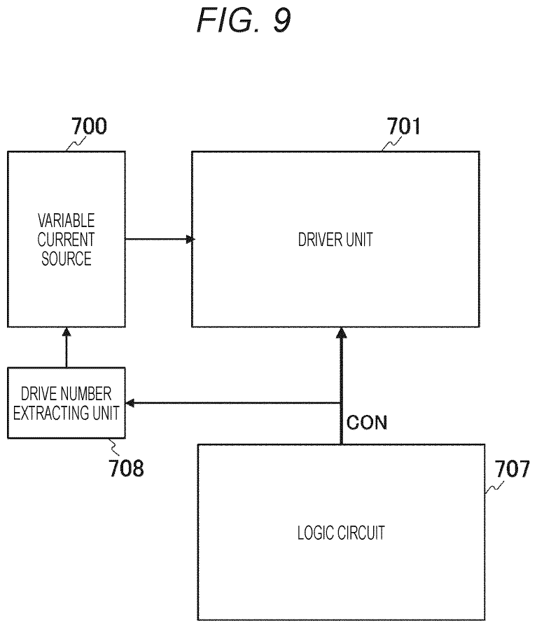

FIG. 9 is a block diagram illustrating a configuration example of a driver circuit according to the second embodiment.

In the drawing, the driver circuit includes a variable current source 700 and a driver unit 701. The variable current source 700 controls a current for driving the driver unit 701 on the basis of a control signal CON for controlling the driver unit 701.

The driver unit 701 is driven with a divided current resulting from dividing the current generated by the variable current source 700 to generate the drive signal for the pixels 111 on the basis of the control signal CON. Note that the driver unit 701 may include the plurality of drivers 201 to 203 of the first embodiment described above. Furthermore, the driver unit 701 may include the switching control units 351 to 353, 361 to 363, 371 to 373, and 381 to 383 in FIG. 3 and the logic circuit in FIG. 5.

The control signal CON can include designation information specifying each of the drivers 201 to 203 that is selected when driving the pixels 111 and a latch signal latching the designation information. The designation information may include an address assigned to each of the drivers 201 to 203. At this time, assuming that the number of drivers 201 to 203 to be simultaneously driven is K (K is an integer greater than or equal to 2), the control signal CON can include K addresses and latch signals that are output in time series from the logic circuit 707.

A drive number extracting unit 708 extracts the number K of drivers 201 to 203 to be simultaneously driven from the control signal CON output from the logic circuit 707 and outputs the number K to the variable current source 700. At this time, the drive number extracting unit 708 may extract the number K of drivers 201 to 203 to be simultaneously driven by counting the latch signals included in the control signal CON.

When the number K of drivers 201 to 203 to be simultaneously driven is output from the drive number extracting unit 708, the variable current source 700 can control the current for driving the driver unit 701 to make the current proportional to the number K.

Furthermore, the driver unit 701 identifies the K drivers 201 to 203 to be simultaneously driven on the basis of the K addresses included in the control signal CON, and holds information identifying the drivers 201 to 203. Then, when the K drivers 201 to 203 are driven, the driver unit 701 generates the trigger signal TRG, the trigger inverted signal XTRG, the shift trigger signal TRG SFT, and the shift trigger inverted signal XTRG SFT in FIG. 5. Then, the driver unit 701 can input these signals to the logic circuit in FIG. 4 to generate the inverted selection signals XA, XB, XC, and XD, and use the inverted selection signals XA, XB, XC, and XD for drive control of the K drivers 201 to 203 to be simultaneously driven. At this time, the driver unit 701 can simultaneously generate the switching signals SA1 to SA3 for the K drivers 201 to 203 from one inverted selection signal XA, and simultaneously generate the switching signals SB1 to SB3 for the K drivers 201 to 203 from one inverted selection signal XB. Furthermore, the driver unit 701 can simultaneously generate the switching signals SC1 to SC3 for the K drivers 201 to 203 from one inverted selection signal XC, and simultaneously generate the switching signals SD1 to SD3 for the K drivers 201 to 203 from one inverted selection signal XD.

Note that the variable current source 700 is an example of the current generation unit described in the claims. The driver unit 701 is an example of the current-driven unit described in the claims.

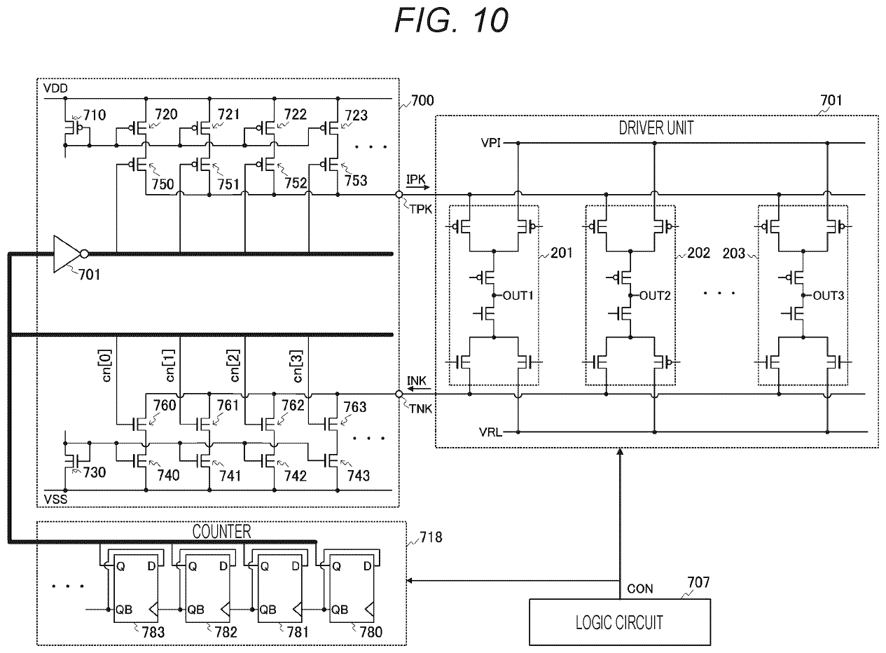

FIG. 10 is a circuit diagram illustrating a configuration example of the driver circuit according to the second embodiment.

In the drawing, the driver unit 701 includes the plurality of drivers 201 to 203. The variable current source 700 is shared by the plurality of drivers 201 to 203. At this time, the drivers 201 to 203 are connected in parallel to the variable current source 700. The variable current source 700 generates a mirror current on the basis of a current mirror operation, and outputs the mirror current as currents IPK and INK. Here, the variable current source 700 can control the currents IPK and INK according to the number K of drivers 201 to 203 to be simultaneously driven. For example, with I denoting a current flowing through each of the drivers 201 to 203 when driven simultaneously, each of the currents IPK and INK can be given as K×I.

The variable current source 700 includes PMOS transistors 710, 720 to 723 and 750 to 753 and NMOS transistors 730, 740 to 743 and 760 to 763. The PMOS transistors 720 to 723 and the PMOS transistors 750 to 753 can be provided as many as the maximum number of drivers 201 to 203 to be simultaneously driven. Furthermore, the NMOS transistors 740 to 743 and the NMOS transistors 760 to 763 can also be provided as many as the maximum number of drivers 201 to 203 to be simultaneously driven.

The PMOS transistors 720 to 723 are connected in series to the PMOS transistors 750 to 753, respectively. The power supply voltage VDD is applied to a source of each of the PMOS transistors 710 and 720 to 723, and each of the PMOS transistors 710 and 720 to 723 has a gate connected to a drain of the PMOS transistor 710. Each of the PMOS transistors 750 to 753 has a drain connected to a current terminal TPK. The current IPK is output from the current terminal TPK to the driver unit 701. Counter outputs cn[0] to cn[3] are input to gates of the PMOS transistors 750 to 753 via the inverter 701, respectively.

The NMOS transistors 740 to 743 are connected in series to the NMOS transistors 760 to 763, respectively. The ground voltage VSS is applied to a source of each of the NMOS transistors 730 and 740 to 743, and each of the NMOS transistors 730 and 740 to 743 has a gate connected to a drain of the NMOS transistor 730. Each of the NMOS transistors 760 to 763 has a drain connected to the current terminal TNK. The current INK drawn from the driver unit 701 flows into the current terminal TNK. The counter outputs cn[0] to cn[3] are input to gates of the NMOS transistors 760 to 763, respectively.

The drive number extracting unit 708 in FIG. 9 is provided with a counter 718. The counter 718 includes flip-flops 780 to 783. In the flip-flops 780 to 783, a D terminal and a QB terminal of the preceding stage are connected to a clock terminal of the subsequent stage. Furthermore, the counter outputs cn[0] to cn[3] are respectively output from Q terminals of the flip-flops 780 to 783 to the variable current source 700.

The control signal CON includes a signal that toggles K times according to the number K of drivers 201 to 203. At this time, the counter 718 performs a counting operation on the basis of the signal toggling K times included in the control signal CON. At this time, K counter outputs among the counter outputs cn[0] to cn[3] become 1, and the K PMOS transistors 750 to 753 and the K NMOS transistors 760 to 763 are simultaneously turned on accordingly. As a result, the currents IPK and INK corresponding to the number K of drivers 201 to 203 to be simultaneously driven are generated, and a divided current resulting from dividing each of the currents IPK and INK into 1/K can be used to drive each of the K drivers 201 to 203.

Note that the counter 718 can reset the counter outputs cn[0] to cn[3] each time the pixel signal is read row by row and repeat the counting operation. The variable current source 700 can therefore update each of the currents IPK and INK each time the pixel signal is read row by row.

As described above, in the second embodiment described above, the number K of drivers 201 to 203 to be simultaneously driven is extracted from the control signal CON, and the currents IPK and INK generated by the variable current source 700 are controlled according to the number K of drivers 201 to 203 to be simultaneously driven. It is therefore possible to current-drive, even when the number K of drivers 201 to 203 to be simultaneously driven is changed, the plurality of drivers 201 to 203 simultaneously while maintaining the slew rate of the drive signals OUT1 to OUT3 constant.

### 3. Third Embodiment

In the second embodiment described above, in order to maintain the slew rate of the drive signals OUT1 to OUT3 constant, the currents IPK and INK generated by the variable current source 700 are controlled according to the number K of drivers 201 to 203 to be simultaneously driven. In this third embodiment, the slew rate of the drive signals OUT1 to OUT3 output from the drivers 201 to 203 is made variable on the basis of the current control of the variable current source.

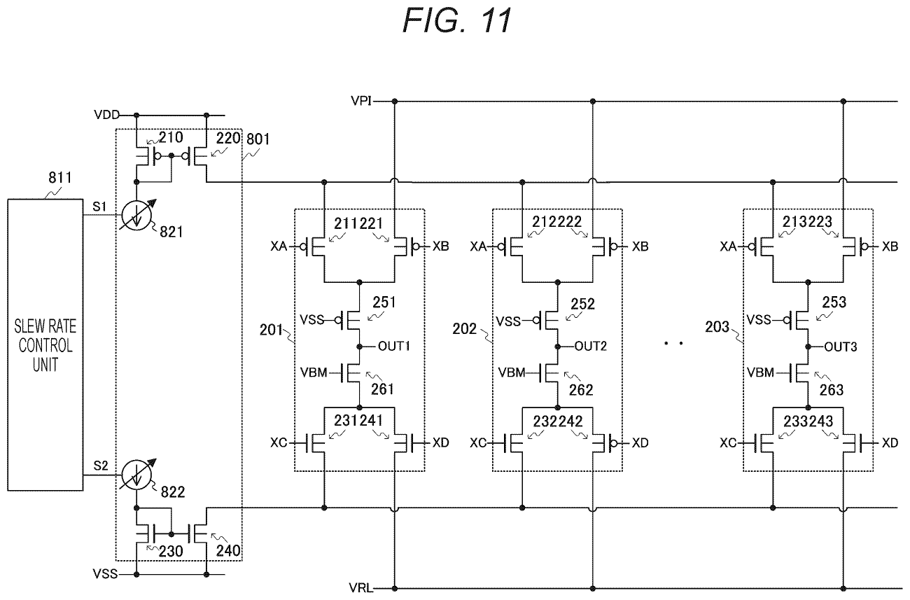

FIG. 11 is a circuit diagram illustrating a first example of a driver circuit according to the third embodiment.

In the drawing, this driver circuit includes a variable current source 801 instead of the current source 200 of the first embodiment described above. Furthermore, the driver circuit is based on the driver circuit of the first embodiment described above and is further provided with a slew rate control unit 811. The other configurations of the driver circuit of the first example of the third embodiment are similar to those of the driver circuit of the first embodiment described above.

The variable current source 801 includes variable current sources 821 and 822 instead of the current sources 250 and 260 of the first embodiment described above. The other configurations of the variable current source 801 are similar to those of the current source 200 of the first embodiment described above.

The variable current source 821 draws a reference current from the drain of the PMOS transistor 210, and the variable current source 822 draws a reference current into the drain of the NMOS transistor 230. Such reference currents are variable. Current control signals S1 and S2 are input from the slew rate control unit 811 to the variable current sources 821 and 822, respectively. At this time, the reference current drawn from the drain of the PMOS transistor 210 and the reference current drawn into the drain of the NMOS transistor 230 can be equal to each other.

The slew rate control unit 811 controls, on the basis of each of the current control signals S1 and S2, the reference current of a corresponding one of the variable current sources 821 and 822. At this time, the slew rate control unit 811 can control the slew rate of the drive signals OUT1 to OUT3 respectively output from the drivers 201 to 203 on the basis of the current control of the variable current sources 821 and 822.

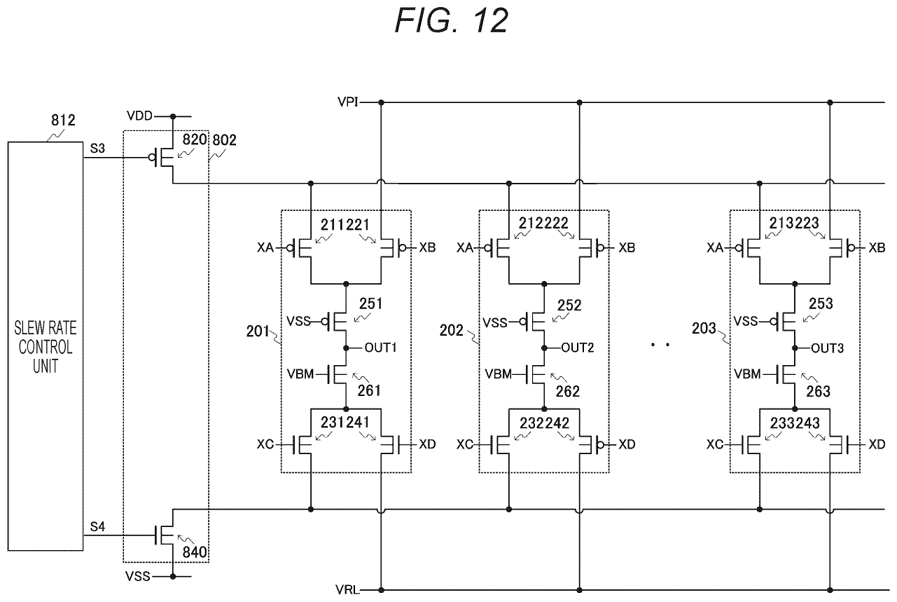

FIG. 12 is a circuit diagram illustrating a second example of the driver circuit according to the third embodiment.

In the drawing, this driver circuit includes a variable current source 802 instead of the current source 200 of the first embodiment described above. Furthermore, the driver circuit is based on the driver circuit of the first embodiment described above and is further provided with a slew rate control unit 812. The other configurations of the driver circuit of the second example of the third embodiment are similar to those of the driver circuit of the first embodiment described above.

The variable current source 802 includes a PMOS transistor 820 and an NMOS transistor 840. The power supply voltage VDD is applied to a source of the PMOS transistor 820, and a current control signal S3 is input from the slew rate control unit 812 to a gate of the PMOS transistor 820. The PMOS transistor 820 has a drain connected to the source of each of the PMOS transistors 211 to 213.

The ground voltage VSS is applied to a source of the NMOS transistor 840, and a current control signal S4 is input from the slew rate control unit 812 to a gate of the NMOS transistor 840. The NMOS transistor 840 has a drain connected to the source of each of the NMOS transistors 231 to 233.

The slew rate control unit 812 controls the current generated by the variable current source 802 on the basis of each of the current control signals S3 and S4. At this time, the slew rate control unit 812 can control the slew rate of the drive signals OUT1 to OUT3 respectively output from the drivers 201 to 203 on the basis of the current control of the variable current source 802.

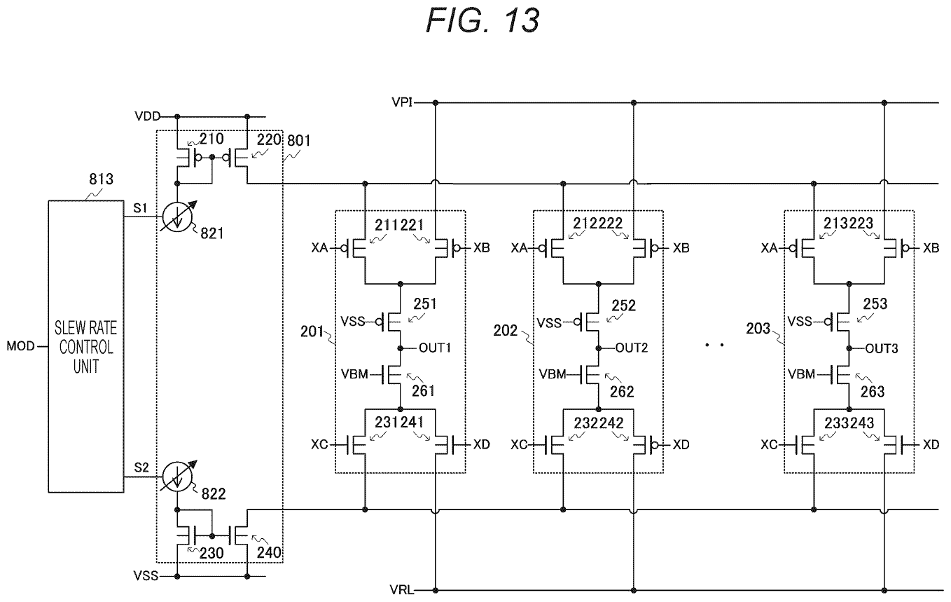

FIG. 13 is a circuit diagram illustrating a third example of the driver circuit according to the third embodiment.

In the drawing, this driver circuit is provided with a slew rate control unit 813 instead of the slew rate control unit 811 of the first example of the third embodiment described above. The other configurations of the driver circuit of the third example of the third embodiment are similar to those of the driver circuit of the first example of the third embodiment described above.

The slew rate control unit 813 controls, on the basis of each of the current control signals S1 and S2, the reference current of a corresponding one of the variable current sources 821 and 822. Here, the slew rate control unit 813 can set each of the current control signals S1 and S2 on the basis of an operation mode instruction signal MOD indicating an operation mode. The operation mode can specify the number of pixels to be read at a time. At this time, the slew rate control unit 813 can control the reference currents of the variable current sources 821 and 822 to maintain the slew rate of the drive signals OUT1 to OUT3 constant even when the number of pixels to be read at a time is changed on the basis of the operation mode instruction signal MOD.

As described above, in the third embodiment described above, the slew rate of the drive signals OUT1 to OUT3 respectively output from the drivers 201 to 203 is controlled with the current for driving each of the drivers 201 to 203 made variable. It is therefore possible to ensure appropriate output waveforms of the drive signals OUT1 to OUT3.

Note that, in the third embodiment described above, the slew rate control of the driver circuit of the first embodiment has been described, but the slew rate control of the third embodiment may be applied to the driver circuit of the second embodiment.

### 4. Fourth Embodiment

In the first embodiment described above, the plurality of drivers 201 to 203 is driven on the basis of the currents IP0 and IN0 generated by one current source 200. In this fourth embodiment, current sources shared by a plurality of drivers are arranged in a distributed manner.

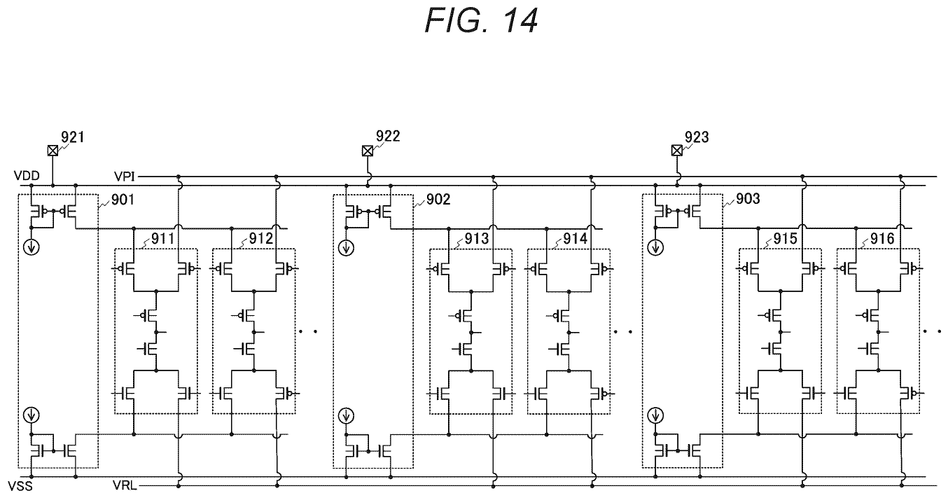

FIG. 14 is a circuit diagram illustrating a configuration example of a driver circuit according to the fourth embodiment.

In the drawing, this driver circuit includes current sources 901 to 903 instead of the current source 200 of the first embodiment described above. Furthermore, the driver circuit is provided with drivers 911 to 916 as the drivers 201 to 203 of the first embodiment described above.

Each of the current sources 901 to 903 can be configured in a manner similar to the current source 200 of the first embodiment described above. The current sources 901 to 903 can be arranged in a distributed manner between the plurality of drivers 911 to 916. At this time, the current source 901 can be shared by the plurality of drivers 911 and 912, the current source 902 can be shared by the plurality of drivers 913 and 914, and the current source 903 can be shared by the plurality of drivers 915 and 916. At this time, the drivers 911 and 912 are connected in parallel to the current source 901, the drivers 913 and 914 are connected in parallel to the current source 902, and the drivers 915 and 916 are connected in parallel to the current source 903.

Furthermore, a power supply line through which the power supply voltage VDD is supplied is connected to a plurality of pad electrodes 921 to 923. Here, it is possible to suppress, by connecting the power supply line through which the power supply voltage VDD is supplied to the plurality of pad electrodes 921 to 923, fluctuations in the power supply voltage VDD caused by IR drop.

As described above, in the fourth embodiment described above, the current sources 901 to 903 shared by the plurality of drivers are arranged in a distributed manner. It is therefore possible to make the wiring drawn from each of the current sources 901 to 903 shorter and reduce the impact of interconnect resistance.

Note that, in the fourth embodiment described above, an example where the current sources are arranged in a distributed manner in the driver circuit of the first embodiment has been described, but the current sources may be arranged in a distributed manner in the driver circuit of the second embodiment.

Furthermore, in the embodiments described above, an example where the driver circuit is applied to the solid-state imaging device 100 has been described, but the driver circuit may be applied to an electronic device other than the solid-state imaging device 100. For example, the driver circuit may be applied to a storage device such as a dynamic random access memory (DRAM), a magnetoresistive random access memory (MRAM), or a NAND flash memory. Alternatively, the driver circuit may be applied to driving of a liquid crystal panel, an organic electro luminescence (EL) panel, or the like, or may be applied to driving of an antenna array.

Furthermore, in the embodiments described above, an example where the PMOS transistors 211 to 213 and the NMOS transistors 231 to 233 to be current-driven and the PMOS transistors 221 to 223 and the NMOS transistors 241 to 243 to be voltage-driven are provided in the driver circuit has been described. Note that a configuration where the PMOS transistors 211 to 213 and the NMOS transistors 231 to 233 to be current-driven serve as the driver circuit eliminates the need of the PMOS transistors 221 to 223 and the NMOS transistors 241 to 243 to be voltage-driven. Furthermore, the withstand voltage protection circuits 271 to 273 need not be included in the driver circuit.

### 15. Example of Application to Mobile Object

The technology according to the present disclosure (the present technology) can be applied to various products. For example, the technology according to the present disclosure may be implemented as a device mounted on any type of mobile object such as an automobile, an electric automobile, a hybrid electric automobile, a motorcycle, a bicycle, a personal mobility, an airplane, a drone, a ship, and a robot.

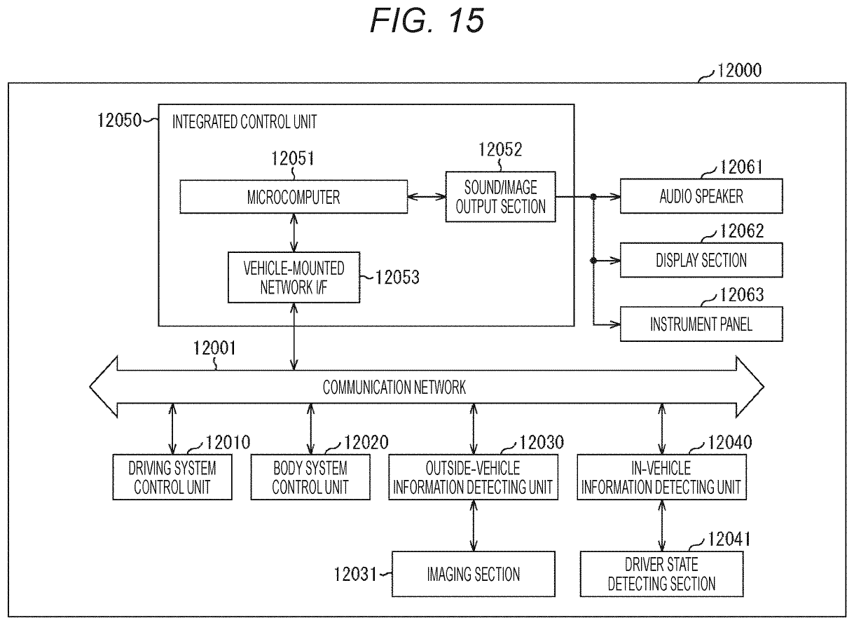

FIG. 15 is a block diagram illustrating a schematic configuration example of a vehicle control system as an example of a mobile object control system to which the technology according to the present disclosure can be applied.

The vehicle control system 12000 includes a plurality of electronic control units connected to each other via a communication network 12001. In the example illustrated in FIG. 15, the vehicle control system 12000 includes a driving system control unit 12010, a body system control unit 12020, an outside-vehicle information detecting unit 12030, an in-vehicle information detecting unit 12040, and an integrated control unit 12050. Furthermore, a microcomputer 12051, a sound/image output section 12052, and a vehicle-mounted network interface (I/F) 12053 are illustrated as functional components of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. Furthermore, the light received by the imaging section 12031 may be visible light, or may be invisible light such as infrared rays.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

Furthermore, the microcomputer 12051 can output a control command to the body system control unit 12020 on the basis of the information about the outside of the vehicle acquired by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example in FIG. 15, an audio speaker 12061, a display section 12062, and an instrument panel 12063 are illustrated as output devices. The display section 12062 may, for example, include at least one of an on-board display and a head-up display.

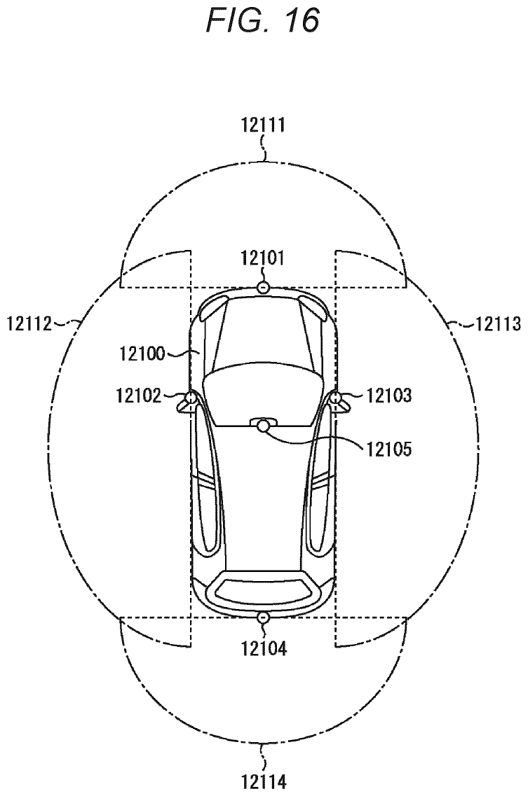

FIG. 16 is a diagram illustrating an example of the installation position of the imaging section 12031.

In FIG. 16, the imaging section 12031 includes imaging sections 12101, 12102, 12103, 12104, and 12105.

The imaging sections 12101, 12102, 12103, 12104, 12105 are provided, for example, at positions such as a front nose, sideview mirrors, a rear bumper, a back door, and an upper portion of a windshield within the interior of a vehicle 12100. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly images of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Note that FIG. 16 illustrates an example of imaging ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been described above. The technology according to the present disclosure can be applied to the imaging section 12031 among the components described above. Specifically, for example, the drive circuit of any one of the first to fourth embodiments described above can be applied to the imaging section 12031. By applying the technology according to the present disclosure to the vehicle control system 12000, it is possible to eliminate non-uniformity of driving of the pixels 111, improve image quality, and reduce power consumption.

Note that the embodiments described above show examples for embodying the present technology, and the matters in the embodiments and the matters specifying the invention in the claims have correspondence relationships. Similarly, the matters specifying the invention in the claims and matters with the same names in the embodiments of the present technology have correspondence relationships. However, the present technology is not limited to the embodiments, and can be embodied by applying various modifications to the embodiments without departing from the scope of the present technology. Furthermore, the effects described herein are merely illustrative and not limiting, and other effects may also be present.

Note that the present technology may also have the following configurations.
(1) A solid-state imaging device including:
a pixel array unit in which pixels are arranged in a matrix in a row direction and a column direction;
a current generation unit that generates a current; and
a current-driven unit that is driven with a divided current resulting from dividing the current generated by the current generation unit to generate a drive signal for the pixels on the basis of a control signal.
(2) The solid-state imaging device according to the above (1),
in which the current generation unit controls the current on the basis of the control signal.
(3) The solid-state imaging device according to the above (2),
in which the control signal includes designation information specifying a current-driven unit that is selected when driving the pixels.
(4) The solid-state imaging device according to the above (3),
in which the designation information includes an address assigned to each of the current-driven units.
(5) The solid-state imaging device according to the above (4),
in which the control signal includes the addresses for a number of the current-driven units to be simultaneously driven, and a signal that is toggled according to the number of the current-driven units to be simultaneously driven.
(6) The solid-state imaging device according to the above (5),
in which the current generation unit controls the current on the basis of the number of the current-driven units to be simultaneously driven extracted from the control signal.
(7) The solid-state imaging device according to the above (6),
in which the current generation unit controls the current on the basis of a counter output of the signal toggled according to the number of the current-driven units to be simultaneously driven.
(8) The solid-state imaging device according to the above (7),
in which the current-driven units identified by the addresses corresponding to the counter output are current-driven simultaneously on the basis of the current controlled on the basis of the counter output.
(9) The solid-state imaging device according to any one of the above (1) to (8), further including:
a voltage-driven unit that is supplied with a second power supply voltage different from a first power supply voltage supplied to the current generation unit to generate a drive signal for the pixels on the basis of the control signal; and
an output terminal provided in common between the current-driven unit and the voltage-driven unit.
(10) The solid-state imaging device according to the above (9),
in which the current-driven unit includes a first switching element having one end connected to the output terminal,
the voltage-driven unit includes a second switching element having one end connected to the output terminal,
the first switching element has the other end connected to a current terminal of the current generation unit, and
the second power supply voltage is supplied to the other end of the second switching element.
(11) The driver circuit according to any one of the above (1) to (10),
in which a plurality of the current-driven units is provided, and
the current generation unit is shared by the plurality of current-driven units.
(12) The driver circuit according to the above (11), in which
the current-driven units are connected in parallel to the current generation unit.
(13) The solid-state imaging device according to the above (9) or (10),
in which the voltage-driven units are provided on a one-to-one basis for the current-driven units, and the second power supply voltage is supplied in parallel to the voltage-driven units.
(14) The solid-state imaging device according to any one of the above (1) to (13),
in which the current-driven unit includes a transistor,
a mirror current generated on the basis of a current mirror operation of the current generation unit flows to a source of the transistor, and
the control signal is input to a gate of the transistor.
(15) The solid-state imaging device according to the above (14), further including a slew rate control unit that controls a slew rate of the current-driven unit on the basis of control of the mirror current generated on the basis of the current mirror operation of the current generation unit.
(16) A driver circuit including:
a current generation unit that generates a current; and
a current-driven unit that is driven with a divided current resulting from dividing the current generated by the current generation unit to generate a drive signal for a transistor on the basis of a control signal.

### REFERENCE SIGNS LIST

101 Pixel array unit
111 Pixel
102 Vertical drive circuit
103 Horizontal drive circuit
104 Control circuit
105 Column signal processing circuit
106 Output circuit
200 Current source
201 to 203 Driver
141 to 143 Withstand voltage protection circuit
151 to 153, 161 to 163, 171 to 173, 181 to 183 Switching element
130 Power supply
131 Step-up circuit
132 Step-down circuit
401 to 404 AND circuit
405 to 408 Inverter

1. A solid-state imaging device comprising:
a pixel array unit in which pixels are arranged in a matrix in a row direction and a column direction;
a current generation unit that generates a current; and
a current-driven unit that is driven with a divided current resulting from dividing the current generated by the current generation unit to generate a drive signal for the pixels on a basis of a control signal.

2. The solid-state imaging device according to claim 1,
wherein the current generation unit controls the current on a basis of the control signal.

3. The solid-state imaging device according to claim 2,
wherein the control signal includes designation information specifying a current-driven unit that is selected when driving the pixels.

4. The solid-state imaging device according to claim 3,
wherein the designation information includes an address assigned to each of the current-driven units.

5. The solid-state imaging device according to claim 4,
wherein the control signal includes the addresses for a number of the current-driven units to be simultaneously driven, and a signal that is toggled according to the number of the current-driven units to be simultaneously driven.

6. The solid-state imaging device according to claim 5,
wherein the current generation unit controls the current on a basis of the number of the current-driven units to be simultaneously driven extracted from the control signal.

7. The solid-state imaging device according to claim 6,
wherein the current generation unit controls the current on a basis of a counter output of the signal toggled according to the number of the current-driven units to be simultaneously driven.

8. The solid-state imaging device according to claim 7,
wherein the current-driven units identified by the addresses corresponding to the counter output are current-driven simultaneously on a basis of the current controlled on a basis of the counter output.

9. The solid-state imaging device according to claim 1, further comprising:
a voltage-driven unit that is supplied with a second power supply voltage different from a first power supply voltage supplied to the current generation unit to generate a drive signal for the pixels on a basis of the control signal; and
an output terminal provided in common between the current-driven unit and the voltage-driven unit.

10. The solid-state imaging device according to claim 9,
wherein the current-driven unit includes a first switching element having one end connected to the output terminal,
the voltage-driven unit includes a second switching element having one end connected to the output terminal,
the first switching element has another end connected to a current terminal of the current generation unit, and
the second power supply voltage is supplied to another end of the second switching element.

11. The driver circuit according to claim 1,
wherein a plurality of the current-driven units is provided, and
the current generation unit is shared by the plurality of current-driven units.

12. The driver circuit according to claim 8,
wherein the current-driven units are connected in parallel to the current generation unit.

13. The solid-state imaging device according to claim 9,
wherein the voltage-driven units are provided on a one-to-one basis for the current-driven units, and the second power supply voltage is supplied in parallel to the voltage-driven units.

14. The solid-state imaging device according to claim 1,
wherein the current-driven unit includes a transistor,
a mirror current generated on a basis of a current mirror operation of the current generation unit flows to a source of the transistor, and
the control signal is input to a gate of the transistor.

15. The solid-state imaging device according to claim 14, further comprising a slew rate control unit that controls a slew rate of the current-driven unit on a basis of control of the mirror current generated on a basis of the current mirror operation of the current generation unit.

16. A driver circuit comprising:
a current generation unit that generates a current; and
a current-driven unit that is driven with a divided current resulting from dividing the current generated by the current generation unit to generate a drive signal for a transistor on a basis of a control signal.
